(19) United States
(12) Patent Application Publication
(10) Pub. No.: US 2008/0221978 A1
(43) Pub. Date: Sep. 11, 2008

(54) Microscale geospatial graphic analysis of voter characteristics for precise voter targeting

(76) Inventors: Richard I. Samuel, Scotch Plains, NJ (US); John Thompson, Scotch Plains, NJ (US)

Correspondence Address: GOODWIN PROCTER L.L.P;ATTN: PATENT ADMINISTRATOR, 620 Eighth Avenue, NEW YORK, NY, 10018, US

(21) Appl. No.: 12/072,459

(22) Filed: Feb. 26, 2008

Related U.S. Application Data
(60) Provisional application No. 60/903,447, filed on Feb. 26, 2007.

(51) Int. Cl. G06Q 99/00; G06F 17/00

(52) U.S. Cl. 705/12; 707/104.1

(57) ABSTRACT

An apparatus and method are provided for selecting a portion of a group of people who live in a defined geographic area that are more likely than the average population in that geographic area to perform a particular action. The apparatus includes a database for storing data. Such data includes indicia of: a group of people who live in the defined geographic area; the geographic location of the residence of each person in the group of people; and the propensity for one or more persons in the group of people who live in a particular residence to perform the particular action. The apparatus also includes a display for showing the relative locations of the residences in the geographic area and a visually recognizable indication of the propensity for one or more persons who live in a particular residence to perform the particular action.

### CROSS-REFERENCE TO RELATED APPLICATIONS

This application claims a benefit of priority to U.S. provisional application Ser. No. 60/903,447, filed Feb. 26, 2007.

### STATEMENT REGARDING FEDERALLY SPONSORED RESEARCH OR DEVELOPMENT

Not applicable.

### REFERENCE OF A “MICROFICHE APPENDIX”

Not applicable.

### FIELD OF THE INVENTION

This invention relates to an apparatus and method for generating a list of names and/or addresses of which it is predicted the people named or the people who reside at have a known characteristic with respect to voting and particularly with respect to what is called “targeting” in election campaigns.

### BACKGROUND OF THE INVENTION

In an election campaign there are various activities which are done to increase the vote for a particular candidate or group of candidates. Some of these activities are directed at all voters and potential voters while others are targeted at a select set of voters and/or potential voters. Broadcast and print media such as TV, radio and newspaper advertising can be broadly directed to all voters and potential voters or, at best, a general class of voters. However, these forms of advertising do not presently allow precise targeting as is required for the most efficient use of resources, such as, direct mail or door to door activities. In the future it is likely that such forms of advertising will be more selective in their reach and enable more precise targeting methods to apply to these modalities as well.

Precise targeting is done based on party registration, the prior record of election results and/or voter turn out records. These results and records are publicly available. Some of these results and records can be obtained in computer usable forms. Simple spreadsheet or database software methods have been applied to sort these results and records in an attempt to categorize voters and/or potential voters into one or more sets reflecting the likelihood of voting in a specific election and/or the likelihood of voting for a particular party or candidate. A voter or potential voter is often characterized in more than one group. For example a single voter can be characterized as likely to vote for a particular party or candidate based on who he or she lives with or what neighborhood he or she lives in but in a different set as to likelihood of voting in a particular election based on his or her recorded voting history or party registration.

Today, a large proportion of voters do not register with a party. These voters are called “independents” or undeclared voters. These voters are harder to classify with regard to which party they will vote for than voters registered with a party.

Certain predictions of which party or candidate is likely to receive the vote from a voter or potential voter are generally made on the basis of past results or party registration within the scope of a voting district. This is so because the voting district is the smallest set of voters for which election results are available. While this form of targeting has some utility, voting districts are sufficiently large such that party stratification in areas smaller than voting districts readily occurs and is obscured by district-level vote analysis. Moreover, areas defined by voting preference often do not closely coincide with district lines. Another impediment is that voting districts do not contain uniform numbers of voters.

Some predictions of which party or candidate a voter and/or potential voter is likely to vote for have been performed on the basis of subsets of voters and/or potential voters within a smaller geographic area in a voting district. However, this approach is best adapted to a coarse scale of analysis. This method becomes statistically unstable when small locally defined areas are involved. In particular, classifications based on this approach become highly sensitive to the size of the area and can often yield conflicting results at subtly different area sizes and shapes. Therefore, for fine scale mapping, this approach becomes unreliable.

Published United States Patent Application 20050187814 entitled “Voter strategically targeted analyzing and reporting system,” having Ser. No. 10/783,545, filed Feb. 20, 2004 and published Aug. 25, 2005 discloses a system in which previously targeted voters that have not yet voted are displayed on a map using geographic location information linked to the voter list to aid in getting out the vote. The method used to generate the initial list of targeted voters is not disclosed.

U.S. Pat. No. 7,174,301 issued on Feb. 6, 2007 to Florance, et al. and entitled “System and method for accessing geographic-based data” discloses in at least FIGS. 125 and 126 and descriptive text, a system and method for executing a map-based search function. On a broad level, the map-based search tool receives a radius, rectangular, or polygonal area drawn over a map by a user and retrieves data related to the coordinates thereof.

### BRIEF DESCRIPTION OF THE INVENTION

In accordance with this invention it has been found that useful predictions of voter and/or potential voter behavior in a future election can be usefully estimated on smaller sets of voters and/or potential voters than by the above prior art systems and methods by employing data having the geographic location of the residence of a voter and/or residences which have no registered voters therein.

This data can be used for targeting by conventional database computer analysis techniques but it has been found in accordance with the preferred embodiment of this invention that by geospatial plotting such locations as a map with indicia of one or more voting characteristics of a family and/or individual, higher resolution targeting can be achieved by visual inspection of the resultant geospatially encoded voting information.

In one embodiment of this invention lists of voters and/or potential voters can be generated by using computer-aided selection techniques.

In another embodiment of this invention additional information about the persons living at that location can be displayed by using computer-aided selection techniques.

The application of these geospatially encoded maps of voter characteristics support a high resolution street by street picture of a town's voting tendencies that can be used for more specific and resource efficient targeting of particular sets of voters.

These results are obtained using a computer system programmed to employ voter data having a plurality of records of voters. The record of each voter having data relating to at least the voters name, residence address, the geographic location of the residence and other data relating to election characteristics of the voter. The computer system includes a program to select one or more of the records and use the data relating to the geographic location of the voters residence and the proximity thereof to another voters residence for comparing voting characteristics of the voters.

A map may be generated showing voters of the same political entity with an overlay of symbols designating the position of all or most of the homes in the township;

A map may also be generated showing one of the voting districts and surrounding areas with a unique symbol designating each of predetermined sets of homes having the same voter registration of the residents therein;

A map may also be generated showing the same voting district and surrounding areas as above with a unique symbol designating each of predetermined sets of homes all having the same party registration and also having the same voter turn out pattern of at least one of the voters therein;

A map may also be generated showing another of the voting districts and surrounding areas as above with a unique symbol designating each of predetermined sets of homes having the same party registration of at least one of the voters therein.

Targeted voters lists may also be generated from the maps.

This invention provides an apparatus for selecting a portion of a group of people who live in a defined geographic area that are more likely then the average population in said geographic area to perform a particular action. The apparatus includes a database for storing data indicative of a group of (1) people who live in the defined geographic area; (2) the geographic location of the residence of each person in the group of people; and (3) the propensity for one or more persons in the group of people who live in a particular residence to perform said particular action; and a display for showing the relative locations of the residences in the geographic area and a visually recognizable indication of the propensity for one or more persons who live in a particular residence to perform the particular action. In one embodiment the group of people are each registered voters in the geographic area and the particular action is related to voting.

The apparatus can also include a selection device which enables the selection of an area on the display indicating a portion of the defined geographic area; and a list generation device for generating a list of select data associated with select visually recognizable indications within the portion of the defined geographic area.

The invention also includes a method for doing the functions of the above apparatus.

### BRIEF DESCRIPTION OF THE DRAWINGS

FIG. 1 is a map of a political entity, such as a township, with the boundaries and designations of voting districts there on;

FIG. 2 is a listing of fields for a voter list having election data as may be purchased from a government agency or a commercial seller of lists;

FIG. 3 is an example of election results, as they are reported by election district, shown on a spreadsheet;

FIG. 4 is a listing of fields for election data, as shown in FIG. 1, with geospatial data added thereto;

FIG. 4a shows a portion of a voter list having some of the fields listed in FIG. 4, including geospatial data;

FIG. 5 is a map of the same political entity shown in FIG. 1 with an overlay of symbols designating the position of all or most of the homes in the township;

FIG. 6 shows, in accordance with one embodiment of this invention, a map of one of the voting districts and surrounding areas shown in FIG. 1 with a unique symbol designating each of predetermined sets of homes having the same voter registration of the residents therein;

FIGS. 7 and 8 each show, in accordance with another embodiment of this invention maps of the same voting district and surrounding areas shown in FIG. 6 with a unique symbol designating each of predetermined sets of homes all having the same party registration and also having the same voter turn out pattern of at least one of the voters therein;

FIG. 9 is a map, in accordance with this invention of another of the voting districts and surrounding areas shown in FIG. 1 with a unique symbol designating each of predetermined sets of homes having the same party registration of at least one of the voters therein.

FIGS. 10 through 13 show, in accordance with another embodiment of this invention a different display of the map of the same voting district and surrounding areas shown in FIG. 6 and ways of generating targeted voters lists from the map.

FIG. 14 is a block diagram showing one embodiment of a system in accordance with this invention.

FIG. 15 shows a computer readable medium having computer-executable instructions for performing a method of this invention.

### DETAILED DESCRIPTION OF THE INVENTION

It should be apparent to those skilled in the art that the described embodiments of the present invention provided herein are illustrative only and not limiting, having been presented by way of example only. All materials not specified in the claims disclosed herein, including programs, commercial computer packages and algorithms, etc may be replaced by alternative materials serving the same or similar purpose, unless expressly stated otherwise. Therefore, numerous other embodiments of the modifications thereof are contemplated as falling within the scope of the present invention as defined herein and equivalents thereto.

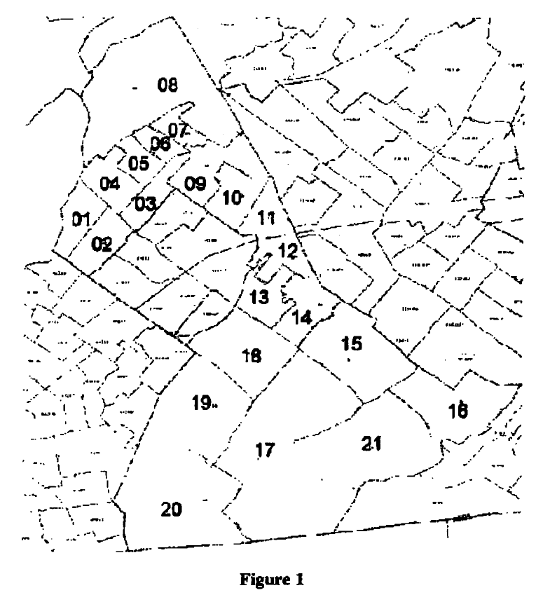

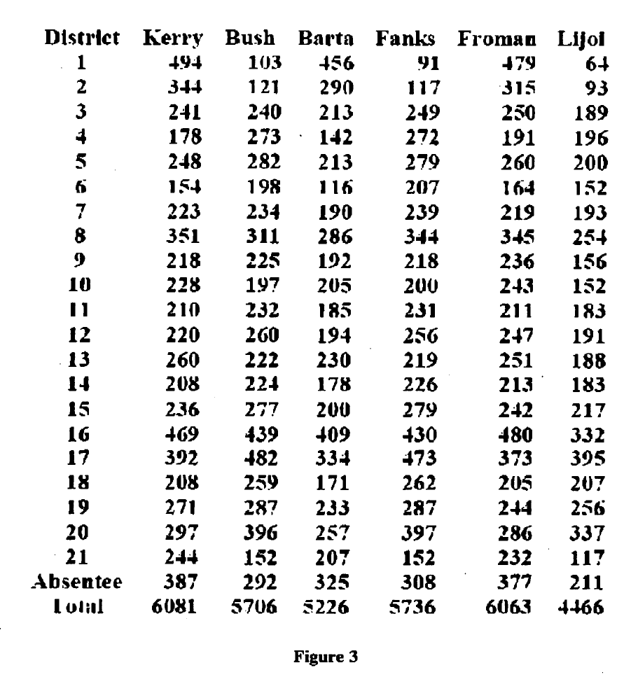

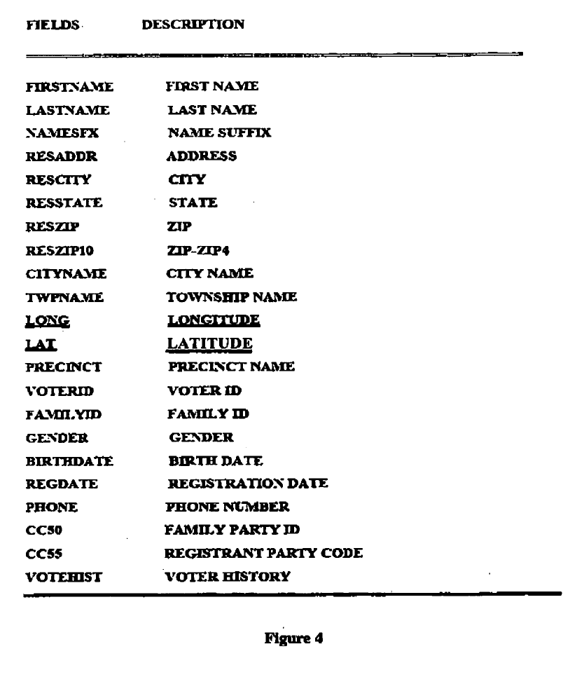

Referring now to FIG. 1, we see a map of a political entity, shown in pink, such as a township, with the boundaries and designations of its 21 voting districts overlaid thereon. FIG. 3 shows a spreadsheet displaying the results of an election in a the jurisdiction of FIG. 1. As can be seen the votes are recorded on a voting district basis so that there are results for each of the 21 voting districts and absentee ballots. Each of these vote results is associated with a defined group of people living in the defined geographic area of the voting district in question.

Often, more than one voting machine is used in a single district and votes for smaller groups than the full voting district are recorded. These recorded votes, however, usually can not be associated with a defined group of people because anyone from that district can vote on any of the voting machines allocated to that district.

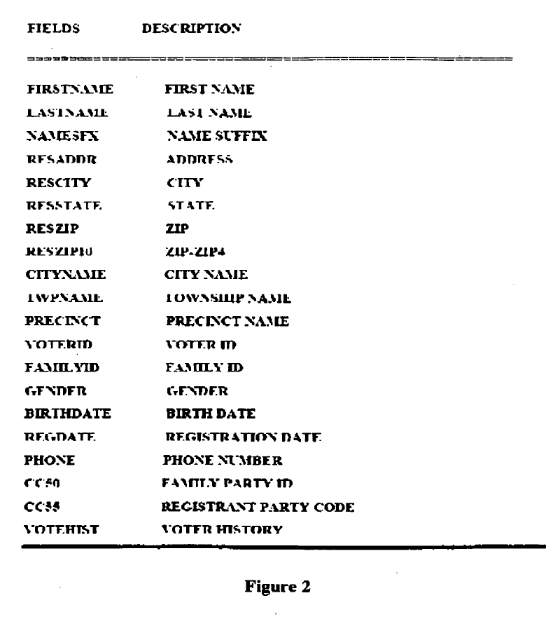

FIG. 2 shows a listing of fields for election data as may be purchased from a government agency or a commercial seller of lists. A record for each registered voter in a jurisdiction is provided in the election data with information that is known in each field. The list of fields shown in FIG. 2 is not an exhaustive list of fields that can be included in such lists. Often as many as 120 fields are employed. Often the fields in the list of FIG. 2 do not apply to the jurisdiction in question so they are left blank. Campaign officials often add fields based on canvassing results or differentiating between voters based on information in one or more of the other fields. The election data is usually loaded into a database or spreadsheet. The voter lists presently available include the name and address of each voter but do not include data designating the geospatial location of such address. These lists also contain the voting history of the voter and the voting district the voter's residence is in.

From the election data of FIG. 2 one can determine from the voter history field who in fact were the people who voted in each district to produce the results shown in FIG. 3. For a current election one would have to wait until the voter history field was updated to determine who in fact were the people who voted in that election.

While a great deal of information is available about each voter and sets can be defined to classify groups of voters by select criteria, it is difficult, at best, to try to find sets of voters that define a community with regard to voting for a particular party. The difficulty is that these communities do not follow voting district boundary lines and may be bigger or smaller than a voting district.

Efforts were made to define sets of voters that define a community with regard to voting for a particular party. This was done by breaking each voting district into smaller geographic areas by using Postal Carrier Routes provided by the United States Postal Service. Carrier Route data is included in the election data of FIG. 2.

This effort was an improvement in the finding of sets in voting districts that predicted voters likely to vote for the same party but suffered from the fact that some areas defined by the Carrier Route-voting district combination were too large and others too small to be useful. Even the ones that were useful did not completely define a desired set because the boundary lines used were arbitrary.

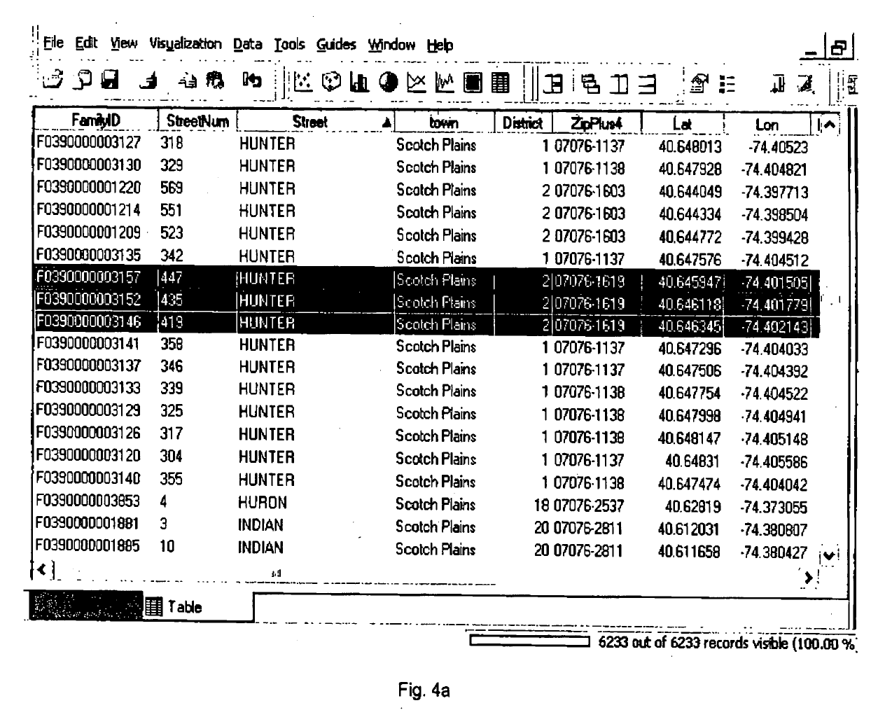

FIG. 4. shows a listing of fields for election data, as shown in FIG. 2, with geospatial data added thereto. The LONG and LAT fields in FIG. 4 are an example of geospatial data. The LONG and LAT fields are underline for easy viewing. FIG. 4a shows a portion of the voter list of FIG. 4. This portion of the voter list shows some of the voters in the township and some of the fields, including LONG and LAT, shown in FIG. 4 of the election data. The geospatial data may take many forms, such as any data which distinguishes locations in the geographic area of interest. The geospatial data may be in a form which directly relates to positions on a display screen.

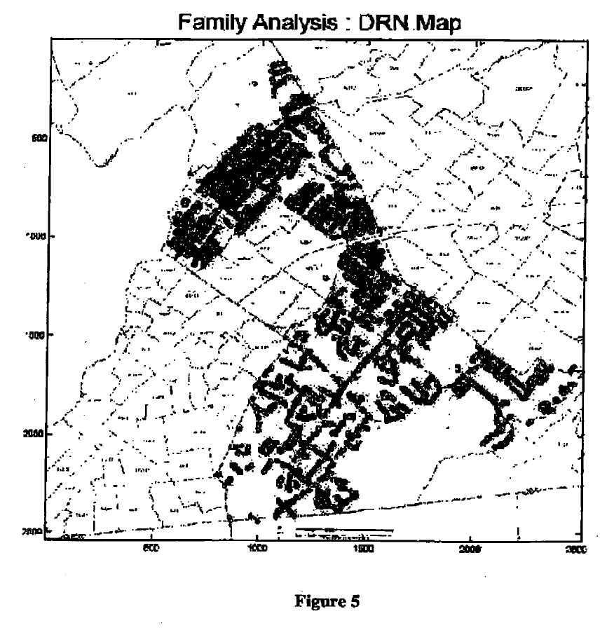

In FIG. 5 we see, in accordance with this invention, a map of the same political entity shown in FIG. 1 with an overlay of symbols designating the position of all or most of the homes in the township. From FIG. 5 we see that the housing density in the township varies a great deal from area to area. As a result, it can be seen that voting districts with high population density are small and ones with low population density are larger. It can also be seen that some areas have regularly spaced housing and others have less regularly spaced housing. This in all probability accounts for the fact that certain prior art targeting methods become statistically unstable when small locally defined areas are used.

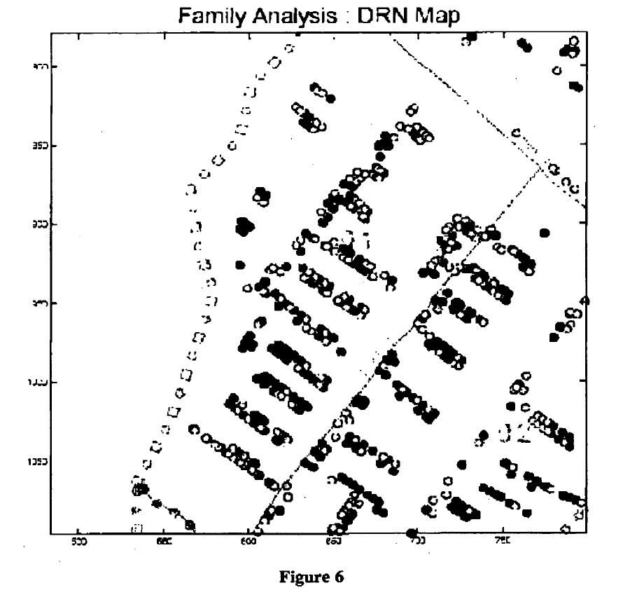

FIG. 6 shows, in accordance with one embodiment of this invention a map of one of the voting districts and surrounding areas shown in FIG. 1 with a unique symbol designating each of a predetermined set of homes having the same party registration of at least one of the voters therein. This information can be obtained from the information in field CC50 in each of FIGS. 2 and 4. In this case the homes with voters registered as Democrats are shown in blue, the homes with voters registered as Republicans are shown in red and the homes with voters not registered with a party are shown in yellow. If one wants the precise registration distribution of the homes of voters a coding system using seven symbols can be use. This system is well known in the art and information relating thereto is found in the field FAMILYID in each of FIGS. 2 and 4. If one wanted to show the number of family members in each category in each home different symbols could be used such as a donut shape with a number in the middle and colors around the outside to indicate the number of voters of each party registration.

It can be seen in FIG. 6 that the area shown on the map is heavily Democratic with a small sprinkling of Republicans. One can also see a large number of independents. It is safe to assume that a large majority of the independents are also Democratic voters. When an entire district is as heavily of one party as shown in FIG. 6 prior art targeting methods can identify them. However, if one looks at the lower left hand corner of FIG. 6 it can be seen that the streets at the edge of the map are more Republican then the rest of the area. This kind of small area targeting cannot be easily performed with prior art methods of targeting. As will be seen, this invention can exclude this area from a voter list being generated by Democrats or included in a voter list being generated by Republicans.

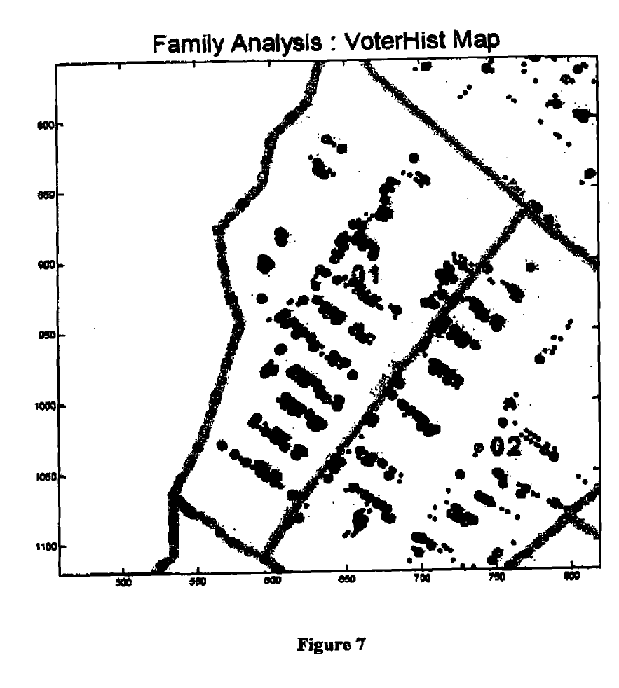

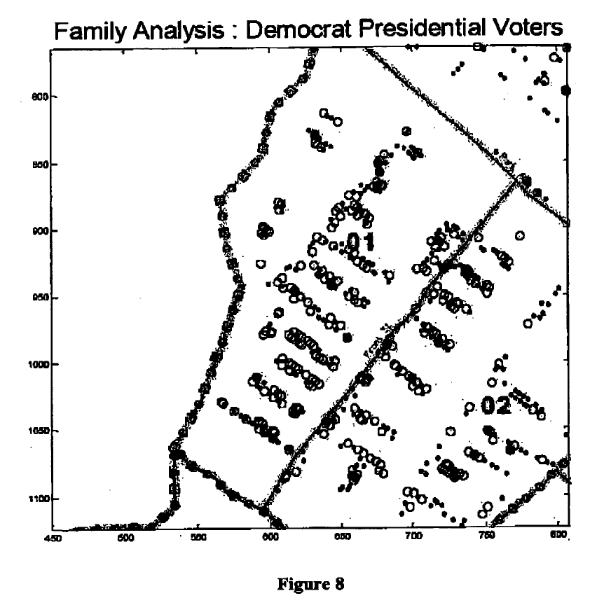

FIGS. 7 and 8 show, in accordance with another embodiment of this invention maps of the same voting district and surrounding areas shown in FIG. 6 with a unique symbol designating each of a predetermined set of homes all having the same party registration and also having the same voter turn out pattern of at least one of the voters therein. This additional information can be obtained in the field labeled VOTERHIST in each of FIGS. 2 and 4. Increasing the number and type of symbols used can give more information about voters turn out history in each house just as was explained with respect to FIG. 6 for party registration. One could also put more than one party on the map with turn out information but at some point the amount of data on the map becomes to cluttered to be useful for a person to make useful distinctions. This amount of data can vary from person to person. Using one or more maps as discussed with respect to FIGS. 7 and 8 one can see where their get out the vote efforts were effective and ineffective in a past election and where the opposition is targeting their get out the vote efforts.

In FIG. 7 the homes with voters who vote regularly are shown in blue, the homes with voters who only vote in Presidential elections are shown in red and the homes with voters who vote in more than just Presidential elections but not regularly are shown in yellow. The homes with voters of a different voter registration are shown as dots

FIG. 8 shows a map of the same voting district shown in FIG. 6 with each of the predetermined set of homes all having the same party registration designated by a circle and the homes of that set who only vote in Presidential elections have the circles filled in with red. Again, the homes with voters of a different voter registration are shown as dots

It should be clear that any kind of election data related to individuals and/or families living in a home can be mapped for easier targeting purposes. For example, it has been found that classifying voters by date of registration and/or age can lead to helpful insights for targeting voters in an election. An example of the use of such information can be seen by distinguishing either by different symbols on one map or using different maps to identify sets of voters who registered in particular years or other interval of time and using, for example a color to designate party registration. This can show if there has been new construction in a particular geographic area of a township which has attracted people of a particular party registration or if there has been an influx of voters in a defined time frame of a particular party registration.

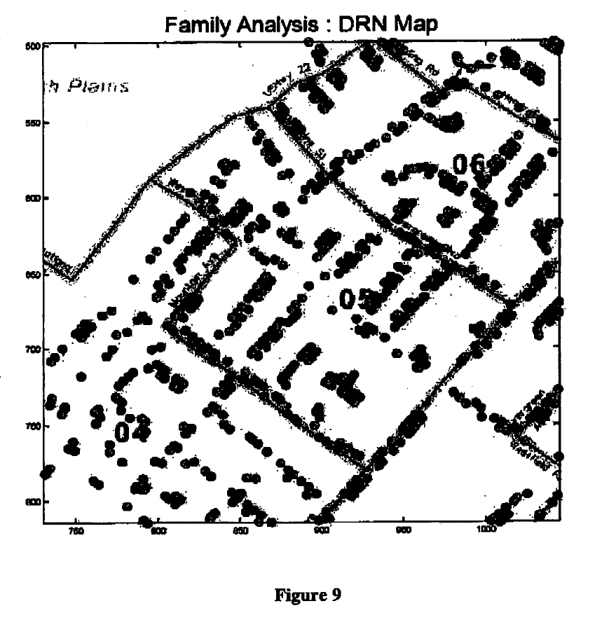

FIG. 9 is a map of another of the voting districts shown in FIG. 1 and surrounding areas with a unique symbol designating each of a predetermined set of homes having the same party registration of at least one of the voters therein. The homes having voters registered as Democrats are shown in blue, the homes having voters registered as Republicans are shown in red and the homes having voters not registered with a party are shown in yellow.

FIG. 9 shows that the area shown therein has a more even distribution of Democrats and Republicans with a larger number of independents intermixed with them than the district shown in FIG. 6. Even though there appear to be more Republicans than Democrats in the present district, it is clear that the distribution of parties is not homogeneous and that clusters of each party exist. Using these clusters of voters registered in a party, the independents in these clusters are likely to lean towards that party. Prior art targeting methods can not estimate party affiliation of independents in areas on so small a scale.

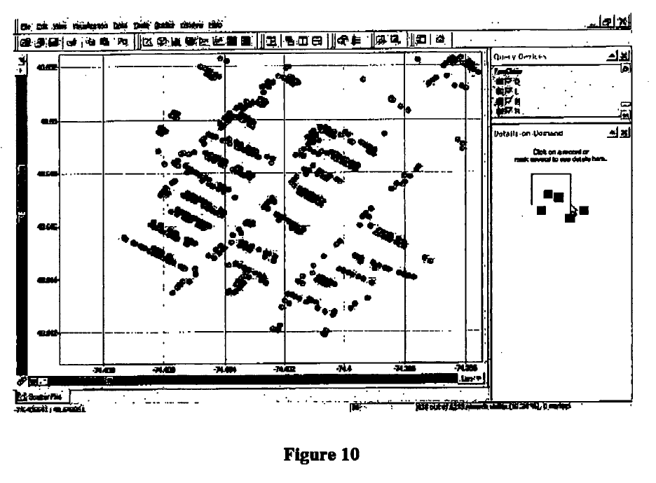

Referring now to FIGS. 10 through 13 we see, in accordance with another embodiment of this invention a different display of the map of the same voting district and surrounding areas shown in FIG. 6 and ways of generating targeted voters lists from the map.

In FIG. 10 we see the new format of the display but the same distribution of homes as in FIG. 6 differentiating in the same way the party affiliation of voters living in each home. It can be seen that this display has three portions as compared to the single portion in FIG. 6. The map is on the left hand side of FIG. 10 and corresponds to the map shown in FIG. 6. On the right top portion of FIG. 10 we see a box labeled Query Devices. Below the title are boxes to be checked, as appear in many programs, showing a color to the left of each and a letter to the right of each indicating different party affiliations. In this Figure, all of the boxes are labeled and we can see on the map that each home is marked with the color that corresponds to its voters political affiliation. It is clear that the Query Devices can be set to different queries such as ones indicating the voters that turn out in a particular election or pattern of voting over a particular time interval. Both the query and the symbol indicating a voting parameter can be changed.

A drop down window can be used to set the query and/or the symbol indicating different values of the data in the field that the query is operating on. More than one field of the data can be involved in the query so two or more drop down windows may be used to set the fields of the query. Of course drop down windows are not the only way to provide for user choices and those skilled in the art will know of many other choices.

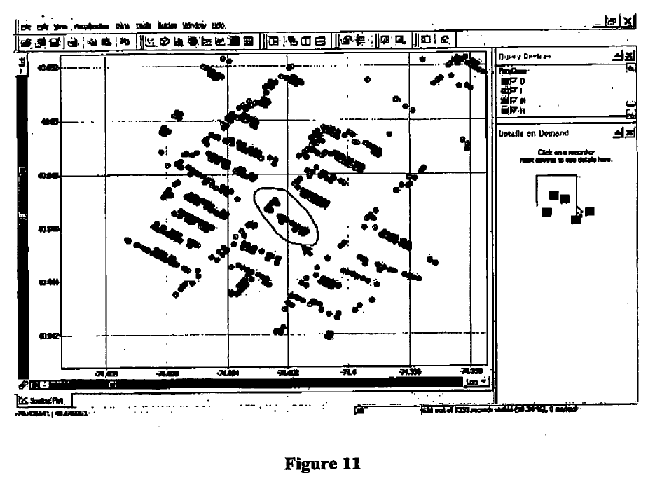

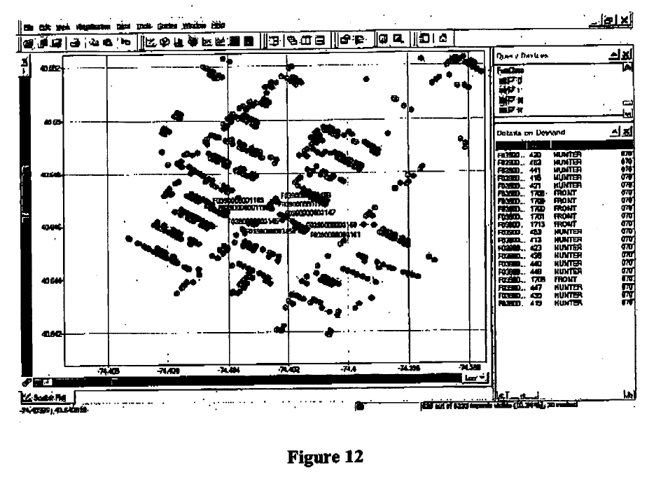

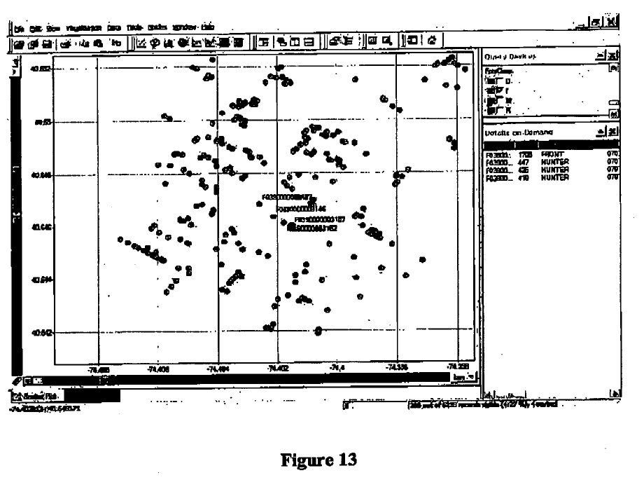

In the lower right hand portion of FIG. 10, we see a box labeled Get Details. In the box it says “Click on a record or mark several to see details here.” In FIG. 11, we see the display of FIG. 10 with a mouse pointer adjacent to a boundary that has been drawn around a cluster of targeted homes by a user guiding the mouse. FIG. 12 shows a list of the records or parts thereof, from the voter list of FIG. 4a, of the voters who live in the targeted homes in the lower right hand box. The targeted homes are colored in green and information from the voter list associated with the voters in each targeted home is displayed next to each of them. Of course many ways of choosing the targeted homes can be used. They can be selected one at a time or by a group. A pointing device is the preferred way of choosing the target homes but other techniques can be used. Other information from the voter list can be displayed about one or more of the voters in the selected home or homes. Only one or combinations of the additions to the display can be used. For example only the list can be displayed, only the color change can occur or only the information adjacent each home could be displayed. Any combination of the above can be displayed or information in any form related to the voters in those homes can be displayed in any format. The records of the targeted voters can be exported to a separate file, added to an existing file or marked for future identification and/or manipulation. In FIG. 13 we see that the checks in three of the boxes have been removed and only the box next to the yellow color and the letter I is checked. On the display it is seen that only the houses previously marked yellow remain on the map and of the targeted voters only those marked in yellow in FIGS. 10 and 11 remain. In the portion of the display in the lower right the records for only the voters living in the targeted homes previously yellow in FIGS. 10 and 11. Again these records can be exported as above.

Thus it is seen that in accordance with this invention targeted lists of voters with additional voting data can be generated by marking visibly distinguishable clusters of symbols on a display.

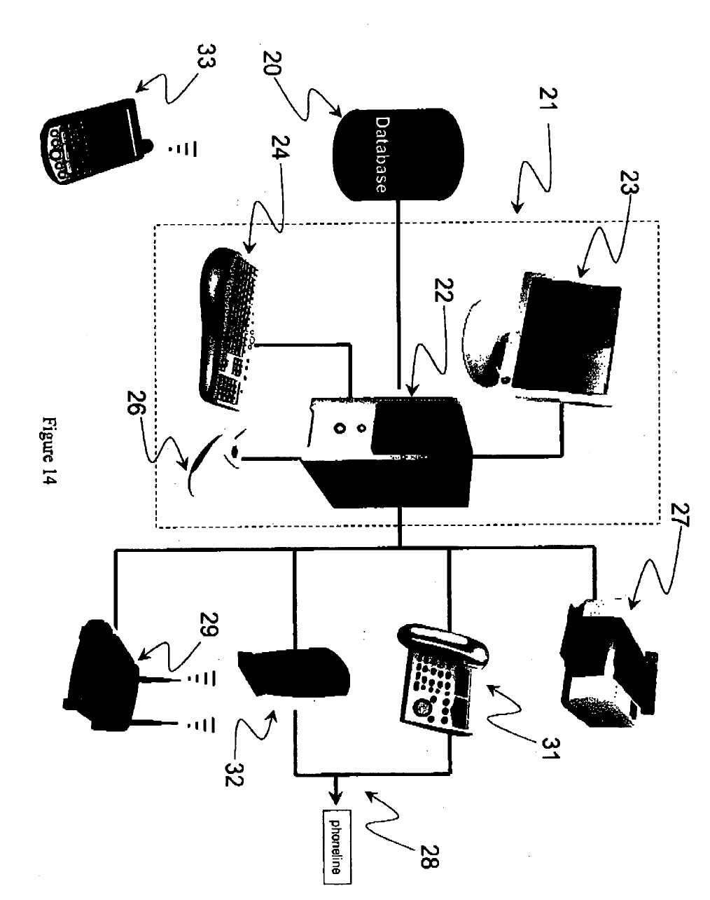

Referring now to FIG. 14, we see a block diagram of a system of a preferred embodiment of this invention. In FIG. 14, there is a data base 20 having one or more tables therein which contain election data for a plurality of registered voters. A record exists for each voter. Each record provides fields for information such information to be stored in the fields shown in FIG. 4. These records include the address for each voter and geospatial data relating to the voters address. Similar records can exist for houses in which no voter lives and geospatial data relating thereto to be used for voter registration purposes. The records may relate to voters and/or houses in one political subdivision such as the township shown in FIG. 1 or more than one such political subdivision. The records usually identify the political subdivision and voting district the voter and/or house is in.

Another table or tables can be included which contains information on election results for one or more years, such as show in FIG. 3. The election results normally are listed for at least a political subdivision overlapping with the election data. This table is usually linked to the election data tables by the election district field. In this way, data displays can be generated showing statistics relating to voters in a particular election and what the results of that election were. This can be used to show the ratio of one party registration voters to the other party registration voters in a particular election. These ratios can be compared from one election to another to determine if different results in that ratio occurred because of particular voters switching the party they voted for or if the ratio of people registered in different parties voted.

Data base 20 can be accessed by a computer system 21 which may include at least a computer device 22, such as a PC or server if a multi-user system is contemplated. The computer includes a monitor 23, a keyboard 24 and a mouse or other pointing device 26.

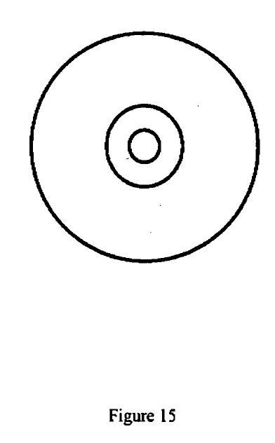

The computer system 21 is programmed using the computer readable medium having computer-executable instructions thereon shown in FIG. 15. The program enables a user of the computer system 21 to perform the methods described above by accessing the database 20 and often also stores new data in the database 20 including new fields to results that may be calculated. The displays shown in FIGS. 5 through 13 are some of the displays which can be generated on the computer monitor 23.

The keyboard 24 can be used to send commands to the computer device 22 to interact with the program in addition to or instead of the pointer device 26. For example, the targeted voter list as shown in FIGS. 12 and 13. These lists can have fields related to the use for which the lists are to be use.

A list generated as above can include information on a targeted list of voters to be called by one or more people on a particular day. List such as these are sent by the computer system 21 to a printer 27. This list would usually include at least a family name and telephone number. A list for mailing would include information required to put on a piece of mail. Such lists can be printed on labels, printed directly on the mail to be sent or sent to a remote printing facility over a telephone line 28 or through a wireless transducer 29. The lists can also be used to operate an automatic message machine 31 or a dialing machine 32 for a phone bank.

The database 20 can be updated by the computer system 21 calculating new or updated information or loading new information received from a data provider. Data providers can send data via email which is downloaded or over a telephone or wireless device. Wireless devices 33 are used today by people sitting at the voting stations to report back on who has voted. This information received in real time can be used to project to vote up to a certain time and or which voters or districts need to be encouraged to vote in order to achieve a desired result.

What is claimed is:

1. An apparatus for selecting a portion of a group of people who live in a defined geographic area that are more likely then the average population in said geographic area to perform a particular action, the apparatus including:
a database for storing data; said data including indicia of:
a group of people who live in said defined geographic area;
the geographic location of the residence of each person in said group of people; and
the propensity for one or more persons in said group of people who live in a particular residence to perform said particular action; and
a display for showing the relative locations of said residences in said geographic area and a visually recognizable indication of the propensity for one or more persons who live in a particular residence to perform said particular action.

2. The apparatus of claim 1 in which said group of people are each registered voters in said geographic area and said particular action is related to voting.

3. The apparatus of claim 2 in which said particular action is voting for candidates of a particular political party.

4. The apparatus of claim 2 in which said particular action is to vote in an election in a particular year.

5. The apparatus of claim 2 in which said defined geographic area is a voting district.

6. The apparatus of claim 5 in which said particular action is voting for candidates of a particular political party.

7. The apparatus of claim 5 in which said particular action is to vote in an election in a particular year.

8. The apparatus of claim 3 in which said visually recognizable indication represents the party registration of at least one of said persons who live at said particular residence.

9. The apparatus of claim 3 in which said visually recognizable indication represents the party registration distribution of said persons who live at said particular residence.

10. The apparatus of claim 2 also including:
a selection device which enables the selection of an area on said display indicating a portion of said defined geographic area; and
a list generation device for generating a list of select data associated with select visually recognizable indications within said portion of said defined geographic area.

11. The apparatus of claim 1 in which said particular action is related to voting.

12. The apparatus of claim 11 also including:
a selection device which enables the selection of an area on said display indicating a portion of said defined geographic area; and
a list generation device for generating a list of select data associated with select visually recognizable indications within said portion of said defined geographic area.

13. A method of selecting a portion of a group of people who live in a defined geographic area that are more likely then the average population in said geographic area to perform a particular action, the method including the steps of:
providing a database for storing data; said data including indicia of:
a group of people who live in said defined geographic area;
the geographic location of the residence of each person in said group of people; and
the propensity for one or more persons in said group of people who live in a particular residence to perform said particular action; and
providing a display for showing the relative locations of said residences in said geographic area and a visually recognizable indication of the propensity for one or more persons who live in a particular residence to perform said particular action.

14. The method of claim 13 in which said group of people are each registered voters in said geographic area and said particular action is related to voting.

15. The method of claim 14 also including:
providing a selection device which enables the selection of an area on said display indicating a portion of said defined geographic area; and
providing a list generation device for generating a list of select data associated with select visually recognizable indications within said portion of said defined geographic area.

16. The method of claim 13 in which said particular action is related to voting.

17. The method of claim 16 also including:
providing a selection device which enables the selection of an area on said display indicating a portion of said defined geographic area; and
providing a list generation device for generating a list of select data associated with select visually recognizable indications within said portion of said defined geographic area.
